(19) United States
(12) Patent Application Publication
(10) Pub. No.: US 2016/0260004 A1
(43) Pub. Date: Sep. 8, 2016

(54) RFID TRANSPONDER WHICH CAN BE OPERATED PASSIVELY

(71) Applicant: ROBERT BOSCH GMBH, Stuttgart (DE)

(72) Inventors: Hans-Juergen HOLLAND, Dresden (DE); Michael HEISS, Dresden (DE); Wolf-Joachim FISCHER, Dresden (DE)

(21) Appl. No.: 14/442,428

(22) PCT Filed: Nov. 15, 2013
(86) PCT No.: PCT/EP2013/073924

§ 371 Date: May 13, 2015

(51) Int. Cl. G06K 19/077

(52) U.S. Cl. CPC G06K 19/0772; G06K 19/07773

(57) ABSTRACT

The invention relates to an RFID transponder which can be operated passively. It is the object of the invention to provide RFID transponders which can be operated passively in the far field, this means over distances of at least 15-20 cm, and which can be manufactured with reduced effort and costs in miniaturized form. In the RFID transponder in accordance with the invention, at least one antenna and one integrated RFID circuit are present on a substrate, The at least one antenna is in this respect included in the form of a dipole antenna and/or patch antenna in the same silicon block, as the substrate, as the integrated circuit. The at least one antenna is in this respect arranged at a minimum distance from the integrated RFID circuit and this minimum distance depends on the respective operating frequency.

The invention relates to an RFID transponder which can be operated passively.

RFID transponders are divided into passive, active and semi-active systems. Passive RFID transponders do not contain any separate energy source or electrical energy stores. The electrical energy required for the operation is provided solely via the magnetic or electromagnetic field formed by a reader, in contrast to this, active or semi-active transponders have their own energy source, for example in the form of a battery or of a solar cell.

A passive transponder therefor only comprises the two components of antenna and integrated RFID circuit. The integrated RFID circuit is in this respect as a rule configured as an integrated circuit which includes the part circuits required for the function of front end with rectifier, demodulator, modulator and voltage regulator and which includes the digital protocol engine for the communication with the reader, for example EPC Gen2. The two components of a passive RFID transponder chip are joined together by means of a suitable design and connection technology, for example by means of a printed circuit board, to form a total system. Such transponders are already known in which RFID electronics and an antenna are integrated together on a chip. However, these solutions are restricted to transponder systems in which the communication between the reader and the transponder takes place in the near field (distance between 10 mm up to approximately 7 cm). In this respect, only the magnetic component of the electromagnetic field is utilized for the transfer of energy and data. No release of an electromagnetic wave from the reader antenna occurs in the near field. Only loop antennas or coils are used for the transmission and reception of the magnetic wave. Due to the low frequencies which are used in the near field range and which are typically at 128 kHz or up to a maximum of 13.56 MHz, the antenna dimensions are so small that an Integration of the antenna is possible on a chip as a substrate and has also already practically been implemented.

However, in the range of higher frequencies, there is a propagation of an electromagnetic wave which is released from the reader antenna, The transponders work in the far field. In this respect, the backscatter principle is used for the transponder, in this respect, the wave modulated and reflected back from the transponder is received by the reader and is evaluated with respect to the information contained, Dipole antennas are typically used for this purpose. An integration of dipole antennas on a chip is, however, not yet known.

With known transponders which work in the far field (backscatter principle), the antenna is often designed as a dipole. The reception and transmission circuits are integrated in a chip. The chip and the antenna are mounted on a carrier. A printed circuit board is also often used in which the antenna is integrated as conductor tracks. A suitable chip with an integrated circuit is then mounted on this printed circuit board. The antenna and chip must be matched to one another. The passive transponder receives its energy from the electromagnetic field via the antenna. Once the energy required for the operation has been taken up, the reception and transmission electronics can start to work. Messages can then be exchanged in both directions between the transponder and a reader via the same electromagnetic field which is also used for the energy transfer. The price of a transponder is increasingly determined by the carrier material (substrate) and by the electrical design and connection technology. The transponders are thus too expensive for many fields of application.

It is therefore the object of the invention to provide RFID transponders which can be operated passively in the far field, this means over distances of at least 15-20 cm, and which can be manufactured with reduced effort and costs in miniaturized form.

This object is achieved in accordance with the invention by RFID transponders having the features of claim 1. Advantageous embodiments and further developments of the invention can be realized using features designated in subordinate claims.

In the RFID transponder in accordance with the invention, at least one antenna and one integrated RFID circuit are present on a substrate. The at least one antenna is in this respect included in the form of a dipole antenna and/or patch antenna in the same silicon block as the integrated circuit. The at least one antenna is in this respect arranged at a minimum distance from the integrated RFID circuit and this minimum distance depends on the respective operating frequency.

The integrated RFID circuit and antenna can advantageously be simultaneously manufactured in a standard CMOS process. For this purpose, a metal layer of the process can be used for the structuring of the antenna. In the event of an arrangement on the rear side of a wafer, the CMOS process can be expanded by the rear side structuring. At the end of the CMOS process, the complete RFID transponder in accordance with the invention can be manufactured. If it is not necessary to set parameters, the complete function test of a plurality of RFID transponders on a wafer can also be carried out in a contactless manner via the transponder field. The manufacture of a probe card can thereby also be dispensed with. In the simplest case, no bond pads are required either.

The frequency-dependent minimum distance should take account of the frequency of the respectively used electromagnetic alternating field (carrier frequency). In this respect, the minimum distance decreases as the frequency increases.

At 24 GHz, the minimum distance is d=100 μm; at 40 GHz d=60 μm and at 60 GHz d=30 μm. The higher the carrier frequency is, the smaller the distance from the antenna should be.

When these conditions are observed, an antenna can also be arranged above the integrated RFID circuit on the substrate in an alternative in accordance with the invention. In this respect, the antenna and the integrated RFID circuit are separated from one another by an electrically insulating layer. This insulating layer can be formed, for example, from a polyamide, another polymer, but also from a ceramic material.

The electrically insulating layer should have a layer thickness which is at least as large as the minimum distance.

An electric contact can be present between the antenna and the integrated RFID circuit and is guided through the electrically insulating layer.

in a second alternative in accordance with the invention, at least one antenna is arranged on the side of the substrate which is disposed opposite the side of the substrate on which the integrated RFID circuit is disposed. In this case, the substrate should have a thickness which corresponds at least to the minimum distance.

In this respect, an electrical contact between the antenna and the integrated RFID circuit should be formed as a via led through the substrate.

In a third alternative in accordance with the invention, at least one antenna and one integrated RFID circuit are arranged on the same surface of the substrate. In this case, a distance is observed between the antenna and the integrated RFID circuit which is at least as large as the minimum distance.

An antenna can be configured in the invention as a metallic coating on a surface of the substrate. In this respect, known coating and structuring processes (e.g. using masks) can be used for its formation.

Antennas can in this respect be formed from a precious metal, aluminum or copper.

in the invention, ail the components which are required for a passive RFID transponder are present integrated on a silicon substrate. In addition to the integrated RFID circuit, the antenna, or also a plurality of antennas, of the RFID transponder is/are present in integrated form in the form of a dipole antenna and/or of a patch antenna for communication in the far field on a silicon substrate or are formed thereat. The mounting of the substrate/chip and antenna on a separate carrier is thus omitted. The whole transponder is produced simultaneously with the chip production.

If the wafer and the chip coordinates are encoded into the identification number, a chip test can take place such that a reader is held in front of the wafer. All the chips on a wafer which can report and can be addressed individually are good systems and can then be read from the wafer and can be used as a transponder after a separation. The substrate can also be formed at least in part from silicon.

If e.g. carrier frequencies of 24 GHz are used, the correspondingly suitable λ/2 dipole antenna has a size of approximately 6.25 mm. With even higher carrier frequencies of the electromagnetic alternating field used, the corresponding λ/2 dipole antenna can be smaller. An antenna can thereby be formed directly in/on silicon.

The minimum distance at a frequency of 24 GHz of the electromagnetic alternating field used should amount to at least 100 μm. The minimum distance can be correspondingly smaller at higher frequencies. The complete RFID transponder can thus be manufactured using otherwise conventional manufacturing technology in the wafer production, Silicon wafers can be used for the substrates of RFID transponders in the manufacture.

The invention will be explained in more detail by way of example in the following.

There are shown:

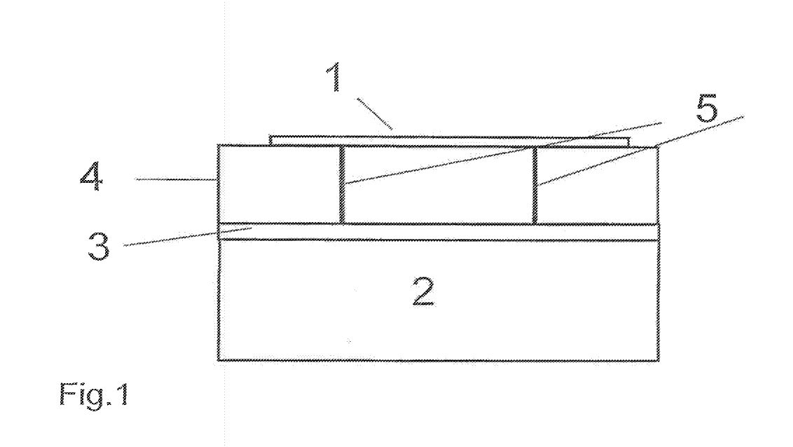

FIG. 1 an example of an RFID transponder in accordance with the first alternative in accordance with the invention;

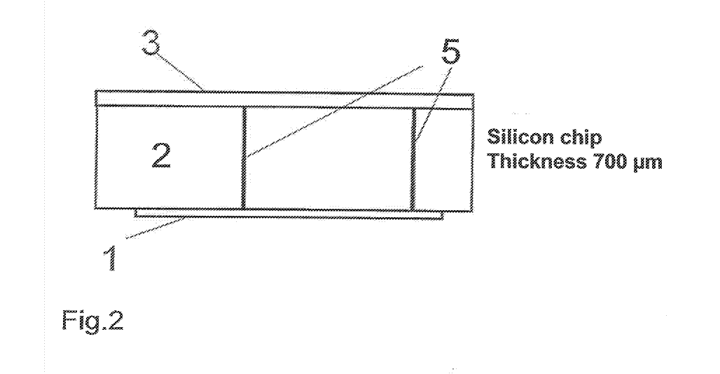

FIG. 2 an example of an RFID transponder in accordance with the second alternative in accordance with the invention; and

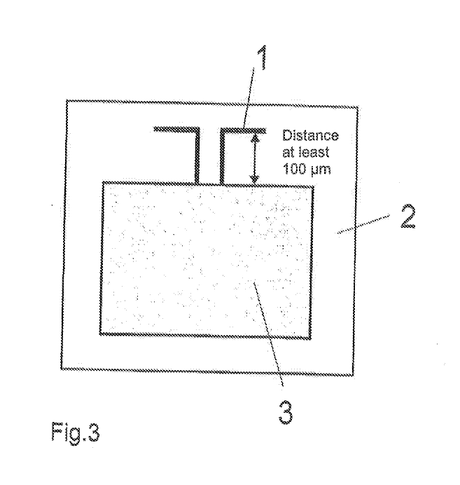

FIG. 3 an example of an RFID transponder in accordance with the third alternative in accordance with the invention.

In the manufacture of an example in accordance with FIG. 1, an antenna 1 is applied above the integrated RFID circuit 3. For this purpose, a thick electrically insulating layer 4, for example a layer of polyamide or of a similar material, is applied over the topmost circuit plane, the integrated RFID circuit. A metal layer is deposited thereon and is structured as an antenna 1. Electrical contacts 5 still have to be formed through the electrically insulating layer 4 for connection to the circuit. The electrically insulating layer 4 in this example has a thickness of 200 μm.

The antenna 1 is configured in this example as a dipole of copper. This also applies to the other examples which will be explained in the following.

In the example shown in FIG. 2, the antenna 1 is arranged on the rear side of the substrate 2. A silicon wafer, which is used as the substrate 2 in all examples, has a thickness of approximately 700 μm. It is thus thick enough to observe the minimum distance between the antenna 1 and the integrated RFID circuit 3. Vias 5 are manufactured through the wafer, as the substrate 2, to the rear side, for example by an etching process with a subsequent filling with an electrically conductive material. A metal is then applied to the rear side and is structured as an antenna 1. In this respect, the dimensioning of the silicon wafer used as a substrate 2 and of a respective RFID transponder has to be observed for the later separation.

In the example shown in FIG. 3, the antenna 1 is arranged next to the integrated RFID circuit 3 or around it. For this purpose, the antenna 1 and a wiring plane of the integrated RFID antenna 3 are arranged at one level, In this case, the minimum distance of 100 μm laterally should be observed.

1. An RFID transponder which can be operated passively in which at least one antenna and one integrated RFID circuit are present on a substrate,
characterized in that the at least one antenna (1) in the form of a dipole antenna and/or of a patch antenna is arranged directly at the substrate (2), which is formed from silicon, at a minimum distance from the integrated RFID circuit (3), with the minimum distance being dependent on the respective operating frequency.

2. An RFID transponder in accordance with claim 1, characterized in that a minimum distance is observed in dependence on the frequency of the respective electromagnetic alternating field used which is utilized for the transfer of data, with the minimum distance being smaller as the frequency increases.

3. An RFID transponder in accordance with claim 1, characterized in that an antenna (1) is arranged above the integrated RFID circuit (3) on the substrate (2) and the antenna (1) and the inte-grated RFID circuit (3) are separated from one another by an electrical-ly insulating layer (4).

4. An RFID transponder in accordance with claim 3, characterized in that the electrically insulating layer (4) has a layer thickness which is at least as large as the minimum distance.

5. An RFID transponder in accordance with claim 3, characterized in that an electrical contact (5) is present between the antenna (1) and the integrated RFID circuit (3) and is guided through the electrically insulating layer (4).

6. An RFID transponder in accordance with claim 1, characterized in that an antenna (1) is arranged on that side of the substrate (2) which is disposed opposite the side of the substrate (2) on which the integrated RFID circuit (3) is arranged.

7. An RFID transponder in accordance with claim 6, characterized in that an electric contact (5) is formed between the antenna (1) and the integrated. RFID circuit (3) as a via led through the substrate (2).

8. An RFID transponder in accordance with claim 1, characterized in that an antenna (1) and an integrated RFID circuit (3) are arranged on the same surface of the substrate (2), with a distance being observed between the antenna (1) and the integrated RFID circuit (3) which is at least as large as the minimum distance.

9. An RFID transponder in accordance with claim 1, characterized in that an antenna (1) is formed as a metallic coating on a surface of the substrate (2).

10. An RFID transponder in accordance with claim 1, characterized in that an antenna (1) is formed from a precious metal, aluminum or copper.

11. An RFID transponder in accordance with claim 1, characterized in that the substrate (2) is formed at least in part from silicon.

12. An RFID transponder in accordance with claim 1, characterized in that the whole RFID transponders is manufactured in a CMOS process.
